(19) United States
(12) Patent Application Publication
(10) Pub. No.: US 2017/0193624 A1
(43) Pub. Date: Jul. 6, 2017

(54) PERSONAL INFORMATION CERTIFICATION AND MANAGEMENT SYSTEM

(71) Applicant: PAYPAL, INC., San Jose, CA (US)

(72) Inventor: John Tsai, San Jose, CA (US)

(21) Appl. No.: 14/984,830

(22) Filed: Dec. 30, 2015

(51) Int. Cl. G06Q 50/26; G06Q 50/00

(52) U.S. Cl. CPC G06Q 50/265; G06Q 50/01

(57) ABSTRACT

Systems and methods for providing personal information certification and management includes receiving, from a first device, a first privacy policy associated with a website, associating the first privacy policy with a first certification, and displaying, on a customer device in response to the determining that the customer device has accessed the website, the first certification. One or more pre-authorized consent configurations associated with the customer is retrieved, from a non-transitory memory. Pre-authorized consent associated with the website is determined according to the one or more pre-authorized consent configurations using the first certification. The pre-authorized consent is sent to the first device.

### BACKGROUND

Field of the Disclosure

The present disclosure generally relates to the management of sharing personal information over electronic networks and more particularly to a personal information certification system that allows customers to manage how their personal information is shared over the electronic networks.

Related Art

More and more people are interacting with others over electronic networks (such as the Internet), including sharing various types of personal information via social networks and when purchasing items and services on-line. For example, people may share family information with others that they are connected to via friend networks such as, for example, those provided by FACEBOOK®, and share business information with others that they are connected to via business networks such as, for example, those provided by LINKEDIN®. As another example, consumers routinely purchase products and services from merchants and individuals. The transactions may take place directly between a conventional or on-line merchant or retailer and the consumer, and payment is typically made by entering credit card or other financial information. Transactions may also take place with the aid of an on-line or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why on-line and mobile purchases are growing very quickly.

A significant tradeoff for enjoying the convenience of online activities is the need to submit personal information to the electronic networks. For example, to complete an online transaction, it is usually necessary to provide personal information (e.g., personally identifiable information (PII)) including name, address, telephone number, email address, credit card numbers, and/or other types of personal information. Providing such personal information concerns customers because once submitted to the website (e.g., a merchant website, a social network website, a financial service provider website, and/or a payment service provider website), the customers lose control of the use the provided personal information. This concern may prevent some users from using the services provided by the websites and/or conducting online transactions to make purchases.

Thus, there is a need to provide for a system for controlling and managing how personal information is utilized.

### BRIEF DESCRIPTION OF THE FIGURES

FIG. 1 is a flow chart illustrating an embodiment of a method for providing personal information certification and management;

FIG. 2 is a screen shot illustrating an embodiment of a system provider device displaying a privacy policy analyzer screen;

FIG. 3 is a screen shot illustrating an embodiment of a merchant device displaying a privacy policy wizard screen;

FIG. 4 is a screen shot illustrating an embodiment of a customer device displaying a privacy policy certification notification screen;

FIG. 5A is a screen shot illustrating an embodiment of a customer device displaying a personal information management configuration screen;

FIG. 5B is a screen shot illustrating an embodiment of a customer device displaying a merchant configuration screen;

FIG. 6 is a screen shot illustrating an embodiment of a customer device displaying pre-authorized consent configuration screen;

FIG. 7 is a screen shot illustrating an embodiment of a customer device displaying an explicit consent request screen;

FIG. 8A is a screen shot illustrating an embodiment of a customer device displaying a certification violation notification screen;

FIG. 8B is a screen shot illustrating an embodiment of a customer device displaying a trust level violation notification screen;

FIG. 9 is a screen shot illustrating an embodiment of a customer device displaying a certification change notification screen;

FIG. 10 is a schematic view illustrating an embodiment of a networked system;

FIG. 11 is a perspective view illustrating an embodiment of a customer device;

FIG. 12 is a schematic view illustrating an embodiment of a computer system; and

FIG. 13 is a schematic view illustrating an embodiment of a system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for providing personal information certification and management. As discussed above, customers may be concerned about the personal information they provided to various websites (e.g., merchant websites, social network websites, financial service provider websites, payment service provider websites and/or any other websites known in the art), which may prevent some customers from conducting online transactions to make purchases, using the services provided by the websites, or simply browsing the websites. To address such concerns, website providers may allow the customers to review their privacy policies, request the customers' consent to those privacy policies, and ensure the customers that the websites' personal information practices comply with their privacy policies and/or other privacy laws and regulation. Conventional provisioning of privacy policies requires customers to read complex privacy policy documents, which may interrupt the online transactions and cause abandonment of the online transactions. However, in embodiments of the systems and methods described herein, a system provider (e.g., the payment service provider discussed below) may provide personal information certifications for the privacy policies of various websites so that customers may quickly and easily understand the general scope of the privacy policies without reading the complex privacy policy documents associated with them. The system provider may allow customers to provide pre-authorized consent to trusted websites or websites that meet high certification standards to provide a more streamlined online transaction experience. Furthermore, the system provider may build consumer confidence in the merchants by auditing the merchants' personal information practices. Moreover, the customers may gain the convenience of managing their personal information collected by various websites using a single system provider.

It is noted that while examples of merchants' web sites provided by merchant devices associated with merchants are discussed below, these examples are not intended to be limiting. The personal information certification and management may be provided to websites provided by a variety of website providers (e.g., social network providers, financial service providers, marketing service providers, and/or any other websites providers known in the art that may collect and/or personal information from customers accessing the websites).

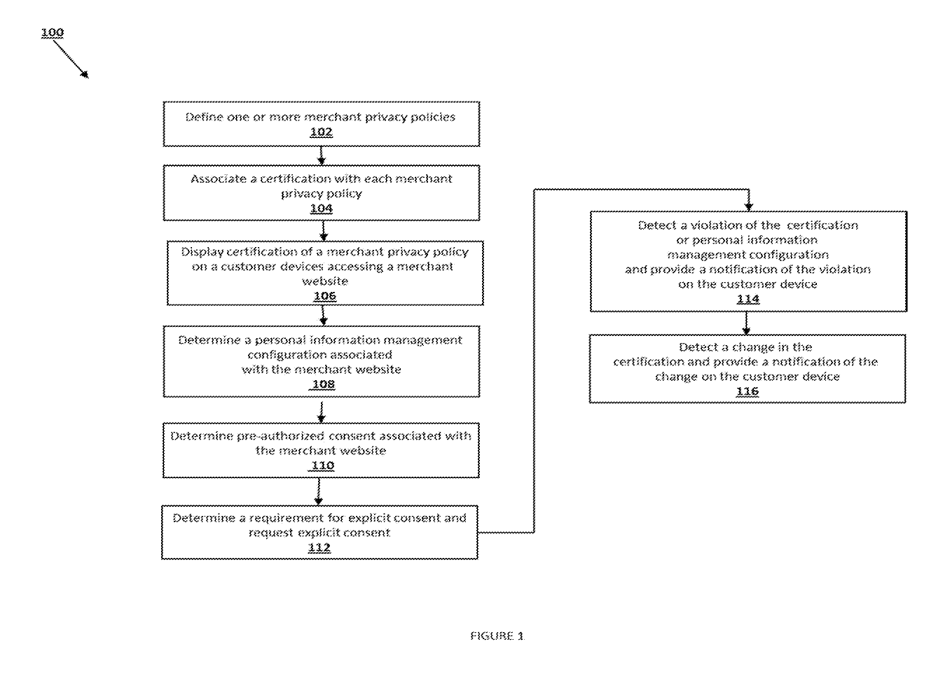

Referring now to FIG. 1, an embodiment of a method 100 for providing personal information certification and management is illustrated. In the embodiments discussed below, a payment service provider such as, for example, PayPal, Inc. of San Jose, Calif. is the system provider and operates a system provider device (e.g., payment service provider device) to help provide customer more control of sending personal information to merchants. However, one of skill in the art in possession of the present disclosure will recognize that a variety of other system providers such as, for example, privacy certification providers, marketplace providers, merchants, and/or other entities will benefit from the teachings herein and thus fall within the scope of the present disclosure.

The method may begin at block 102, where the service provider receives and/or defines one or more privacy policies. In some embodiments, the system provider device 200 may receive the privacy policy associated with a merchant website from a merchant device associated with the merchant. In some embodiments, the system provider device 200 may receive a privacy policy associated with a service provider website (e.g., facebook.com) from a service provider device associated with the service provider. The system provider device 200 may analyze the received privacy policy to extract privacy policy information associated with the received privacy policy. For example, the system provider device 200 may receive a text file including the full privacy policy from the merchant device, and extract the privacy policy information from the text file using various information extraction techniques including natural language analysis, machine learning techniques, any suitable information extraction technique known in the art, and/or a combination thereof.

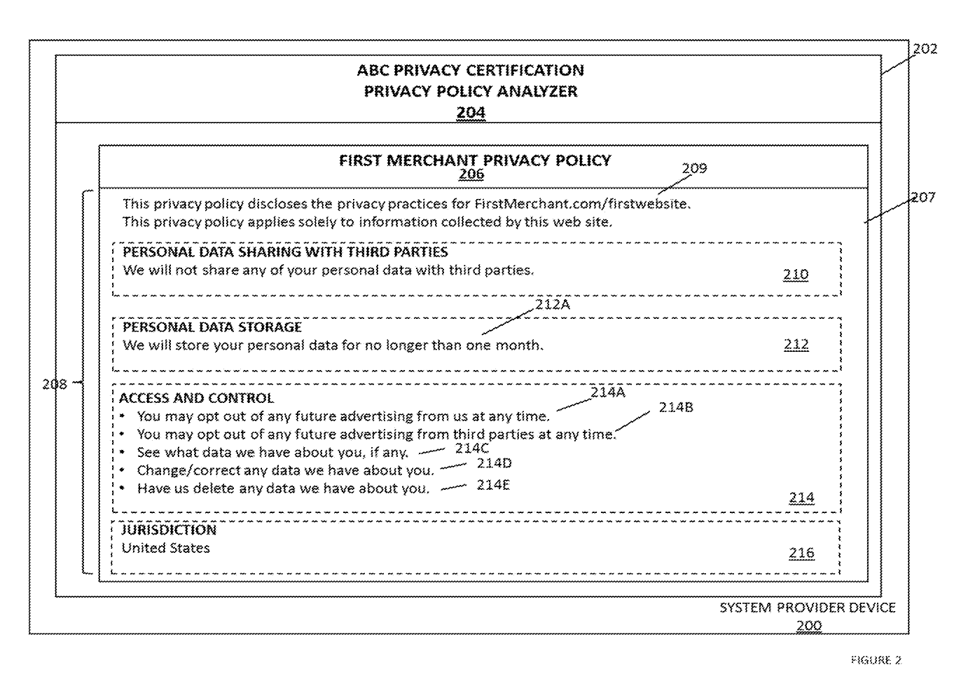

Referring now to FIG. 2, illustrated is an example of a privacy policy analyzer screen 204 displayed on a display device 202 of a system provider device 200. The privacy policy analyzer screen 204 includes a privacy policy section 206 includes an example of a text file of a full privacy policy 207 received from a merchant (e.g., a “First Merchant”). The system provider device 200 may extract privacy policy information 208 associated with the privacy policy 207. In the illustrated example of FIG. 2, the privacy policy information 208 may include merchant website information 209 (e.g., “FirstMerchant.com/firstwebsite”), third parties sharing information 210 (e.g., “We will not share any of your personal data with third parties.”) indicating whether and how the personal information may be shared with third parties, storage information 212 (e.g., “We will store your personal data for no longer than one month.”) including storage period information 212A (“no longer than one month) indicating how long the personal information may be stored (e.g., “We will store your personal data for no longer than one month.”), access and control information 214 indicating how the customers may access and control the personal information collected and stored by the merchant, and/or any other types of privacy policy information known in the art. In some examples, the access and control information 214 may include opt out information 214A (e.g., “You may opt out of any future advertising from us at any time.”) indicating whether and how the customer may opt out of future advertising from the merchant using the personal information and opt out information 214B (e.g., “You may opt out of any future advertising from third parties at any time.”) indicating whether and how the customer may opt out of future advertising from third parties. In some examples, the access and control information 214 may further include access and control information 214C indicating whether and how the customer may access the personal information, access and control information 214D indicating whether and how the customer may correct the personal information, access and control information 214E indicating whether and how the customer may delete the personal information, and/or other types of access and control information known in the art.

Alternatively, in some embodiments, instead of receiving the full privacy policy, the system provider device 200 may receive particular types of privacy policy information associated with the privacy policy from the merchant device by sending the merchant device a privacy policy request including the requested privacy policy types. For example, the privacy policy request may include a merchant website identifier (e.g., “FirstMerchant.com/firstwebsite”), a jurisdiction identifier (e.g., “United States,”), privacy policy information types (e.g., “third parties sharing information,” “storage information,” and/or “access and control information”), and/or a variety of other information about the merchant website that the privacy policy information is being requested for. The merchant device may then gather the requested privacy policy information and send it to the system provider device 200.

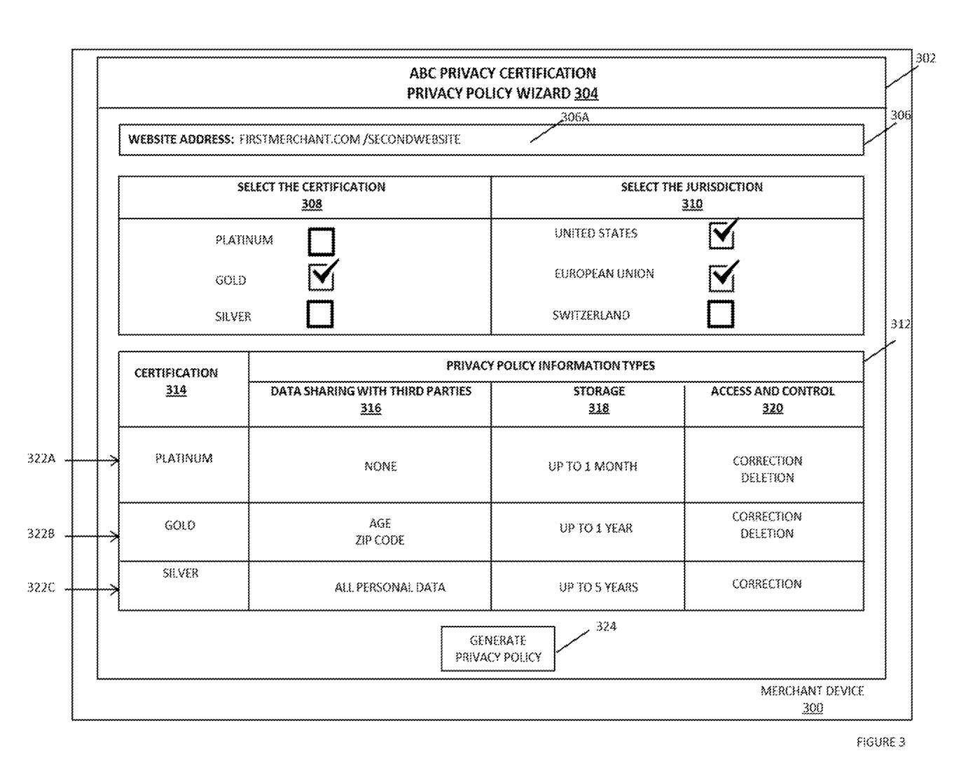

In some embodiments, the system provider device 200 may generate a privacy policy for a merchant website provided by the merchant device. Referring now to FIG. 3, illustrated is an example of a privacy policy wizard screen 304 displayed on a display device 302 of a merchant device 300. The privacy policy wizard screen 304 includes a merchant website identifier section 306, a certification section 308, and a jurisdiction section 308. An operator of the merchant device 300 may provide the merchant website (e.g., “FirstMerchant.com/secondwebsite”) in the merchant website identifier section 306, select the desired certification (e.g., “Gold”), and select the jurisdiction(s) (e.g., “United States” and “European Union”) as the jurisdiction(s) associated with the privacy policy to be generated in the jurisdiction section 310.

In some embodiments, the privacy policy wizard screen 304 may include a certification requirement section 312 including certification requirements 322A, 322B, and 322C, each of which is associated with a particular certification 314 and the corresponding personal information requirements. For example, the certification requirement 322A may provide that to be associated with a “Platinum” certification (e.g., a relatively higher level of certification), the privacy policy is required to meet the third parties sharing requirement 316 (e.g., “None”) requiring that no data may be shared with third parties, storage requirement 318 (e.g., “Up to 1 month”) requiring that the personal data may be stored by the merchant device only for up to one month, and access and control requirement 320 (e.g., “Correction, Deletion”) requiring that the customer may correct and delete the personal data collected and stored by the merchant device 300. For further example, the certification requirement 322B may provide that to be associated with a “Gold” certification (e.g., a relatively intermediate level of certification), the privacy policy is required to meet the third parties sharing requirement 316 (e.g., “Age”, “Zip Code”) requiring that only particular types of personal information may be shared with third parties, storage requirement 318 (e.g., “Up to 1 year”) requiring that the personal data may be stored by the merchant device 300 for up to one year, and access and control requirement 320 (e.g., “Correction, Deletion”) requiring that the customer may correct and delete the personal information collected and stored by the merchant device 300. For further example, the certification requirement 322C may provide that to be associated with a “Silver” certification (e.g., a relatively lower level of certification), the privacy policy is required to meet the third parties sharing requirement 316 (e.g., “All Personal Data”) providing that all personal data collected and stored by the merchant device 300 may be shared with third parties, storage requirement 318 (e.g., “Up to 5 years”) requiring that the personal information may be stored by the merchant device for up to five years, and access and control requirement 320 (e.g., “Correction”) requiring that the customer may correct the personal information collected and stored by the merchant device 300.

In some embodiments, the operator of the merchant device 300 may select the “Generate Privacy Policy” button 324, and the system provider device 200 may generate a privacy policy associated with the particular website provided by the merchant device 300, and send the privacy policy to the merchant device 300. In the illustrated example of FIG. 3, the generated privacy policy may be associated with a “Gold” certification because it meets the certification requirement 322B.

In some embodiments, the privacy policy and the associated privacy policy information may be stored in a privacy policy certification database coupled to the system provider device 200 and/or the merchant device 300.

Referring back to FIG. 1, the method 100 then proceeds to block 104, where a certification may be associated with each privacy policy. In some embodiments, the system provider device 200 may retrieve the privacy policy information associated with the privacy policy (e.g., from a privacy policy certification database), and determine the certification associated with the privacy policy based on the certification requirements (e.g., certification requirements 322A, 322B, and 322C). Referring now to the example of FIG. 2, the system provider device 200 may retrieve the privacy policy information 208 associated with the privacy policy 207, and may associate a particular certification (e.g., “Platinum”) with the privacy policy 207 by determining that the privacy policy information 208 meets the certification requirement (e.g., the certification requirement 322A) for the particular certification. For example, the system provider device 200 may determine that the third parties sharing information 210 of the privacy policy information 208 meets the third parties sharing requirement 316 of the certification requirement 322A, the storage information 212 of the privacy policy information 208 meets the storage requirement 318 of the certification requirement 322A, and the access and control information 214 of the privacy policy information 208 meets the access and control requirement 320 of the certification requirement 322A.

In some embodiments, the certification may be determined by the system provider device 200 based on an audit performed on the personal information practices of the merchant device 300 (e.g., by the system provider device 200, or an auditing provider device). In various embodiments, the audit may determine the personal information practices (e.g., how personal information is collected and/or used) of the merchant device 300, and determine whether the personal information practices of the merchant device 300 are consistent with the privacy policy and/or meet the personal information requirements associated with certification. In an example, the system provider device 200 may determine that the personal information practices of the merchant device 300 are not consistent with the privacy policy and/or do not meet the personal information requirements associated with certification, and may not provide a certification for the merchant website.

In some embodiments, the certification may be determined by the system provider device 200 based on a compliance checking (e.g., performed by the service provider device 200 or an auditing provider device) which determines whether the privacy policy and the personal information practices of the merchant device 300 comply with privacy laws and regulations of the corresponding jurisdiction(s). The jurisdiction(s) may be determined using the location information provided by the customer device 400 and/or the location of the merchant. In an example, the system provider device 200 may not provide a certification for the merchant website if the privacy policy or personal information practices of the merchant device 300 do not comply with the relevant privacy laws and regulations.

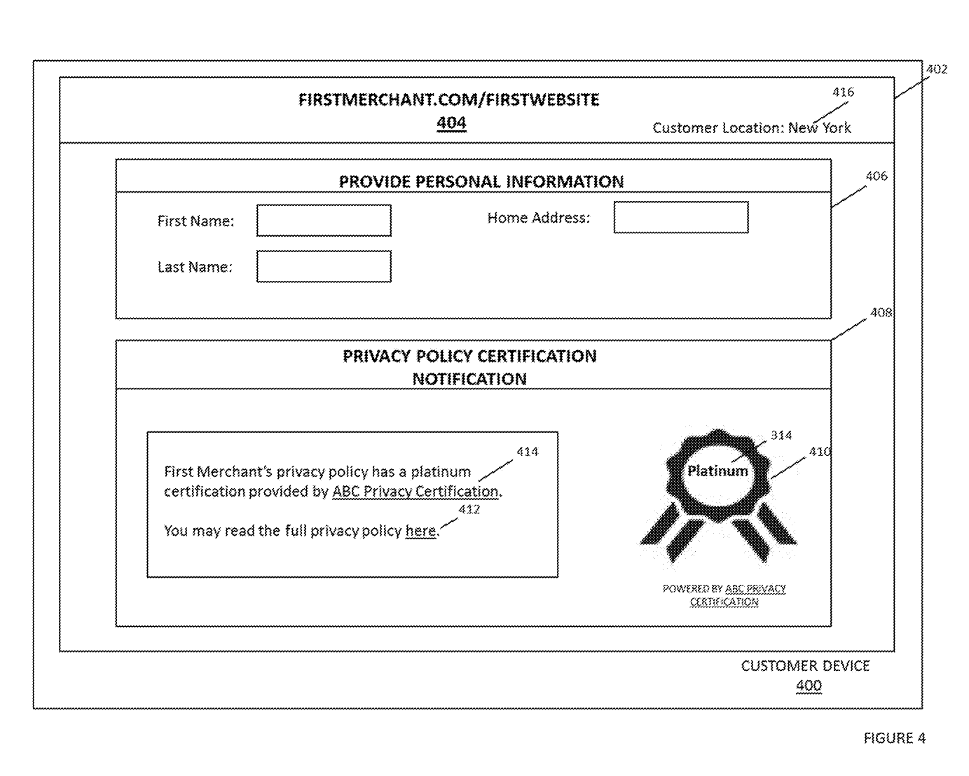

Referring back to FIG. 1, the method 100 then proceeds to block 106, where a certification is retrieved (e.g., from a personal information certification database) by the system provider device 200 and displayed on a customer device accessing the merchant website. Referring now to FIG. 4, illustrated is an example of a privacy policy certification notification screen 404 displayed on a display device 402 of a customer device 400 accessing the merchant website (e.g., “FirstMerchant.com/firstwebsite”). The privacy policy certification notification screen 404 includes a personal data collection section 406 requesting the customer to provide various types of personal information (e.g., “First Name,” “Last Name,” “Home address”) to a merchant website. In some embodiments, at this stage, the merchant website has not collected personal information from the customer.

In some embodiments, the system provider device 200 may determine that personal information is being requested by the merchant website, and provide a privacy policy certification notification section 408 (e.g., using a widget) on the privacy policy certification notification screen 406 of the customer device 400. Such privacy policy certification section 408 may help the customers understand the privacy policy associated with the merchant website, assure the customers that the customers can trust the merchant website with their personal information because the merchant's personal information practices are up to a vigorous sets of standards certified by a trusted third party (e.g., “ABC Privacy Certification” provided by the system provider device 200), and encourage the customers to conduct online transactions to make purchases and increase revenues for merchants.

In some embodiments, the privacy policy certification notification section 408 may include a certification seal 410, a privacy policy link 412, and a seal provider 414. For example, the certification seal 410 may include the certification 314 (e.g., “Platinum”) provided by the seal provider 414 (e.g., “ABC Privacy Certification”). In some embodiments, the customer may read the full privacy policy by selecting the privacy policy link 412. In some embodiments, the seal provider 414 includes a seal provider link (e.g., directing to a service provider website provided by the “ABC Privacy Certification”), and the customer may select the seal provider link to learn more about the seal provider 414.

Referring back to FIG. 1, the method 100 then proceeds to block 108, where the system provider device 200 may retrieve a personal information management configuration associated with the merchant website. In various embodiments, personal information management configurations may be used to provide the customers the convenience of managing the collection and usage of their personal information by various merchants using a single system provider provided by the system provider device 200. In an example, using the personal information management configurations, the customers may configure the trust levels associated with particular merchants (e.g., based on past experience or the general reputation of the merchants). In another example, the customers may configure personal information types that are permitted to be collected by particular merchants. In another example, the customers may configure the technologies that may be used by the merchant website in collecting the customer's personal information. In some embodiments, the system provider device 200 may provide the personal information management configuration associated with the merchant website to the merchant device. In an example, the merchant device may update a customer personal information profile associated with the customer using the personal information management configuration, and configure its personal data collection and usage associated with the customer according to the customer personal information profile.

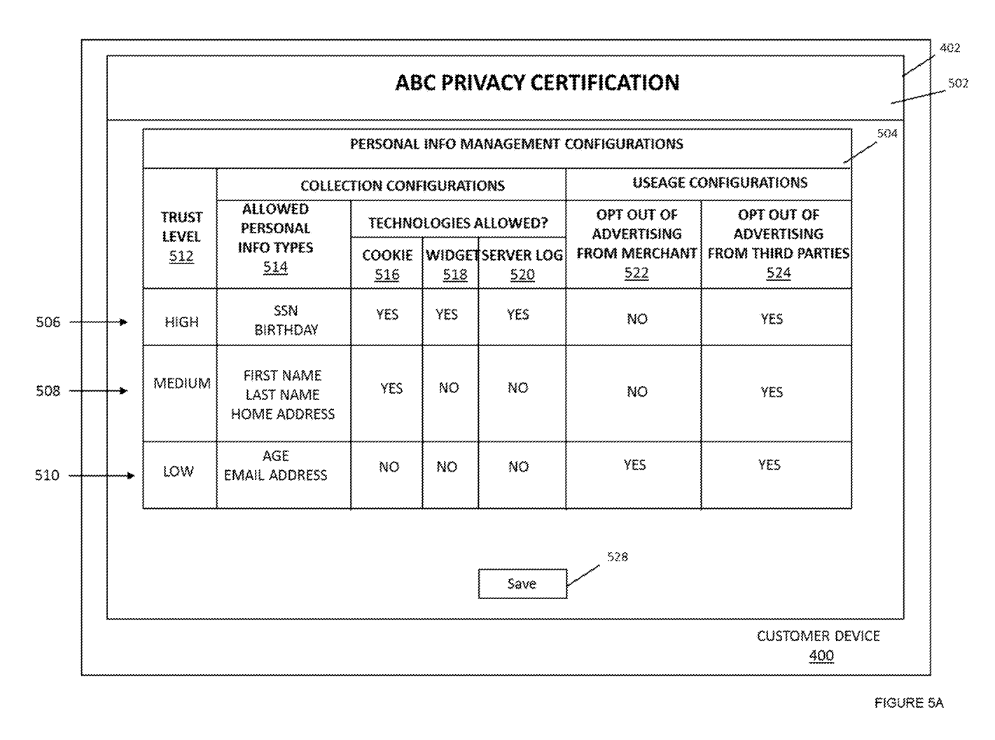

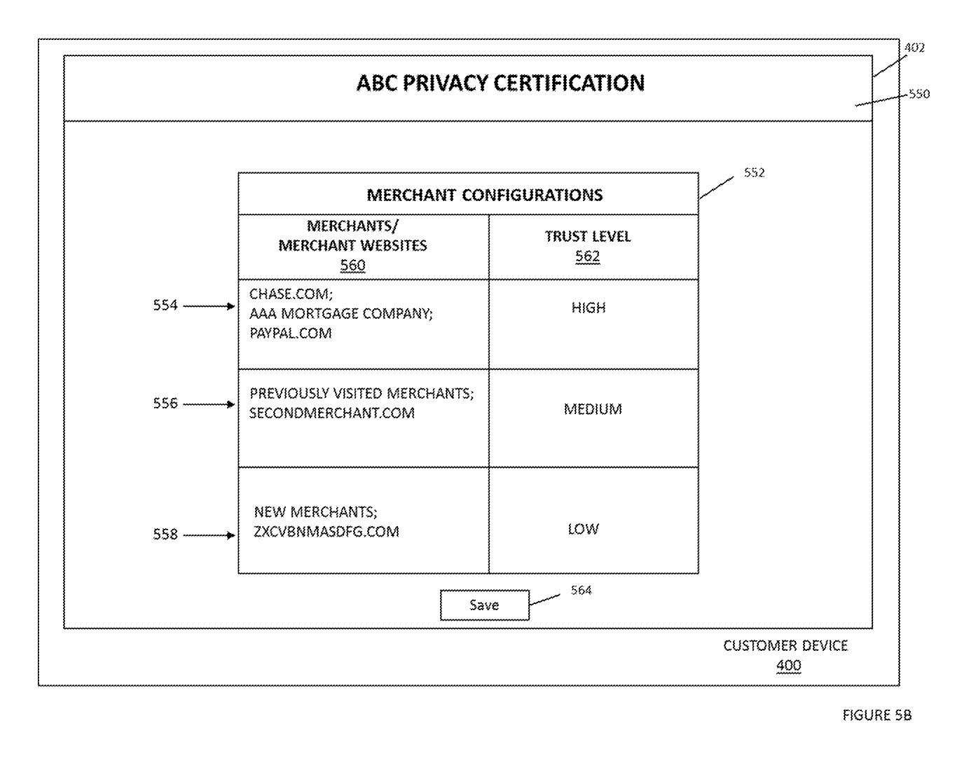

Referring now to FIG. 5A, illustrated is an example of a personal information management configuration screen 502 displayed on a display device 402 of a customer device 400. The personal information management configuration screen 502 includes a personal information management configuration section 504, which includes various personal information management configurations 506, 508, and 510. Each personal information management configuration may include a trust level information 512, collection configurations (e.g., allowed personal information types 514, technology information 516, 518, and 520) indicating the customer's choices regarding how personal information may be collected, and usage configurations (e.g., opt out information 522 and 524) indicating the customer's choices regarding how personal information may be used. In the illustrated example of FIG. 5A, the personal information management configuration 506 may provide that for a merchant website with a “High” trust level, the customer may allow the merchant website to collect particular types of personal information (e.g., “SSN,” “Birthday”), may not opt out of future advertising from either the merchant or the third parties, and may allow the merchant website to use various technologies (e.g., “Cookie,” “Widget,” “Server Log”) to collect personal information. For further example, the personal information management configuration 508 may provide that for a merchant website with a “Medium” trust level, the customer may allow the merchant website to collect particular types of personal information (e.g., “First Name,” “Last Name,” “Home Address”), may not opt out of future advertising from the merchant, may opt out of future advertising from the third parties, and may allow the merchant website to use a smaller set of technologies (e.g., “Cookie”) than those allowed for the merchant website with a “High” trust level. For further example, the personal information management configuration 510 may provide that for a merchant website with a “Low” trust level, the customer may allow the merchant website to collect some personal information (e.g., “Age,” “Email Address”), may opt out of future advertising from both the merchant and the third parties, and may allow the merchant website to use a smaller set of technologies (e.g., none of “Cookie,” “Widget,” and “Server Log”) than those allowed for a merchant website with a “Medium” trust level.

In some embodiments, the customer may add, remove, and/or edit the various personal information management configurations. For example, each of the trust level information 512, allowed personal information types 514, opt out information 522 and 524, technology information 516, 518, and 520 of the personal information management configurations may be editable by the customer. In some embodiments, the customer may select the save button 528 if the customer would like to save the changes that the customer has made to the personal information management configurations.

In some embodiments, the personal information management configurations may include merchant configurations, which may be used by the customer to specify the corresponding trust levels associated with merchants and merchant websites. Referring now to FIG. 5B, illustrated is an example of a merchant configuration screen 550 displayed on a display device 402 of a customer device 400. The merchant configuration screen 550 includes a merchant configuration section 552, which includes various merchant configurations 554, 556, and 558 which may associate merchants or merchant websites with the personal information management configurations (e.g., by using the trust levels). For example, the merchant configuration 554 may provide that some bank websites (e.g., “Chase.com”), mortgage companies (e.g., “AAA Mortgage Company”), and payment service providers (e.g., “PayPal.com”) may have a “High” trust level, and may be associated with the corresponding personal information management configuration 506. For further example, the merchant configuration 556 may provide that websites provided by a particular merchant (e.g., “SecondMerchant.com”) and websites provided by previously visited merchants (e.g., “Previously Visited Merchants”) may have a “Medium” trust level, and may be associated with the corresponding personal information management configuration 508. For further example, the merchant configuration 558 may provide that websites provided by a particular merchant (e.g., “ZXCVBNMASDFG.COM”) and websites provided new merchants that the customer has not previously visited (e.g., “New Merchants”) may have a “Low” trust level, and may be associated with the corresponding personal information management configuration 510.

In some embodiments, the customer may add, remove, and/or edit the various merchant configurations. For example, each of the merchant information 560 and the trust level information 562 of the merchant configurations may be editable by the customer. In some embodiments, the customer may select the save button 564 if the customer would like to save the changes that the customer has made to the merchant information 560 and the trust level information 562 of the merchant configurations.

In some embodiments, the system provider device 200 may determine a trust level associated with a merchant website, and retrieve a personal information management configuration (e.g., from a personal information management database coupled to the system provider device 200) associated with the trust level for the merchant website. In an example, when the customer is visiting a new website, the system provider device 200 may determine that this is the first time that the customer visits any website provided by the merchant, assign a “Low” trust level to the new website according the merchant configuration 558, and retrieve a personal information management configuration 510 associated with the “Low” trust level for the merchant website.

In some embodiments, the system provider device 200 may send the retrieved personal information management configuration associated with the merchant website to the merchant device, and the merchant device may use the received personal information management configuration to manage the personal data collection and usage by a merchant device 300 associated with the customer. For example, the system provider device 200 may send the personal information management configuration 510 associated with the new website to a merchant device 300, which may in response update a customer personal information profile associated with the customer using the personal information management configuration 510. In one example, the customer personal information profile of the merchant device 300 is configured according to the opt out information 522 and 524 of the personal information management configuration 510, so that no advertising may be sent to the customer either by the merchant device 300 or third parties. In another example, the customer personal information profile of the merchant device 300 is configured according to the technology information 516, 518 and 520 of the personal information management configuration 510 so that the merchant device may use cookies, but not widgets nor server logs to collect personal information on the new website from the customer.

Referring back to FIG. 1, the method 100 then proceeds to block 110, where it is determined whether the customer has provided pre-authorized consent to a privacy policy associated with the merchant website. In some embodiments, the pre-authorized consent is determined using pre-authorized consent configurations, where customers may provide pre-authorized consent based on the certification of the merchant website provided by the system provider device 200, the trust level associated with the merchant website, any other suitable factors for determining pre-authorized consent, or a combination thereof. In some embodiments, after determining that a merchant website that has the customer's pre-authorized consent, the pre-authorized consent may be sent to the merchant device and in response, the customer may not be required to read the full privacy policy associated with the merchant website and provide explicit consent, thereby achieving a more streamlined online transaction experience.

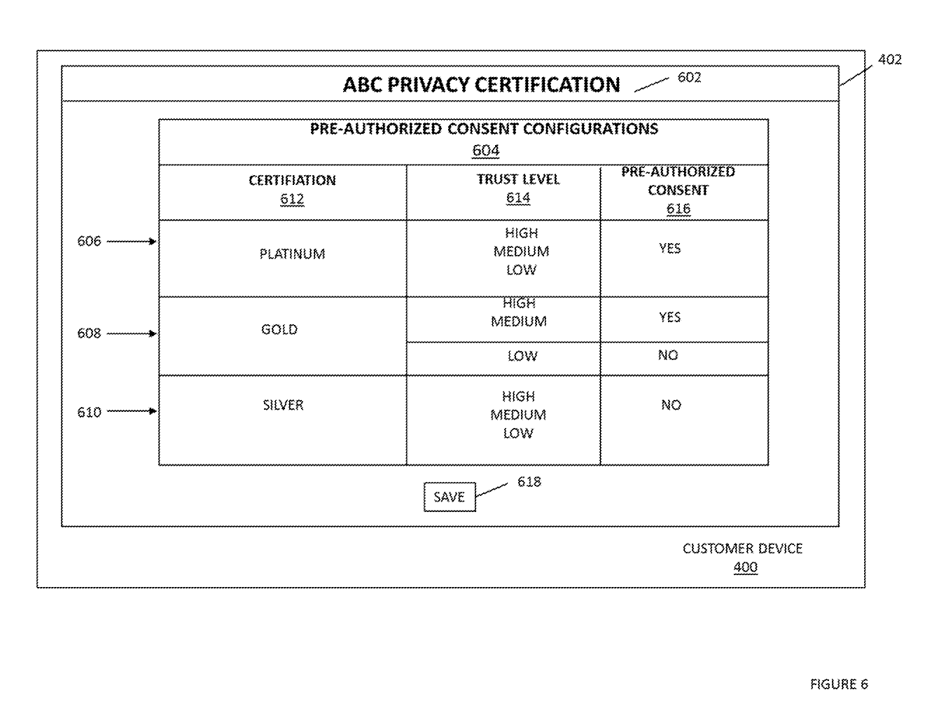

Referring now to FIG. 6, an embodiment of the customer device 400 is illustrated that includes the display device 402 displaying pre-authorized consent configuration screen 602 including pre-authorized consent configuration section 604. The pre-authorized consent configuration section 604 may include various pre-authorized consent configurations 606, 608, and 610. In an example, the pre-authorized consent configuration 606 may provide that regardless of the associated trust level, for a merchant website having a “Platinum” certification, the customer agrees to provide pre-authorized consent to the terms of the privacy policy associated with the merchant website. In another example, the pre-authorized consent configuration 608 may provide that for a merchant website having a “Gold” certification, pre-authorized consent is provided to merchant websites with particular trust levels (e.g., “High” and “Medium”). In another example, the pre-authorized consent configuration 610 may provide that for merchant websites having a “Silver” certification, the customer does not provide pre-authorized consent regardless of the associated trust level.

In some embodiments, the customer may add, remove, and/or edit the various pre-authorized consent configurations. For example, each of the certification information 612, trust level information 614, and pre-authorized consent information 616 of the pre-authorized consent configurations may be editable by the customer. In some embodiments, the customer may select the save button 618 if the customer would like to save the changes that the customer has made to the certification information 612, trust level information 614, and pre-authorized consent information 616 of the pre-authorized consent configurations.

Referring now to FIG. 1, the method 100 proceeds to block 112, where it is determined that explicit consent to the personal information practices of the merchant website is required and in response, an explicit consent request is sent to the customer device 400.

In some embodiments, the system provider device 200 may determine explicit consent is required based on the determination that no pre-authorized consent is provided to the merchant website by the customer.

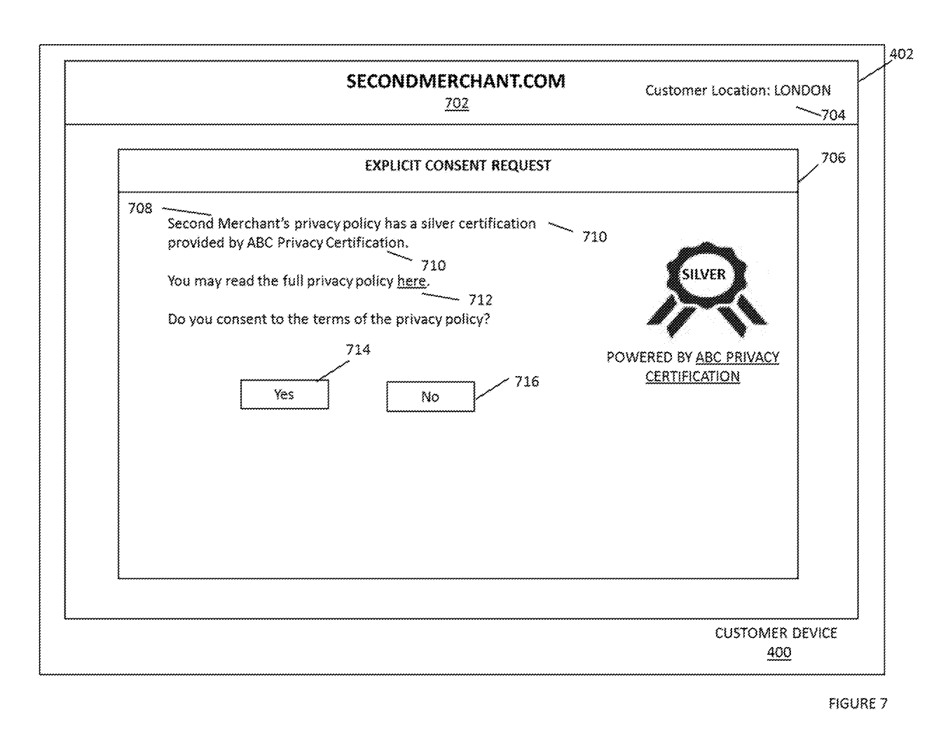

Alternatively, in some embodiments, the system provider 200 may determine that explicit consent is required based on the jurisdiction associated with the location of the customer device 400 and/or the location of the merchant regardless of whether pre-authorized consent has been provided by the customer. Referring now to FIG. 7, an embodiment of the customer device 400 is illustrated that includes the display device 402 displaying an explicit consent request screen 702 including a customer location section 704 displaying a particular location (e.g., “London”) provided by the customer device 400. The system provider 200 may determine the customer is visiting the merchant website (e.g., “SecondMerchant.com”) from the particular location, determine a jurisdiction (e.g., “European Union”) associated with the location, and determine that according to the laws and regulations of the jurisdiction, explicit consent is required regardless of whether pre-authorized consent has been provided by the customer. In response, the system provider 200 may request explicit consent from the customer by displaying an explicit consent section 706 in the explicit consent request screen 702 on the customer device 400. The explicit consent request section 706 may include the merchant information 708 (e.g., “Second Merchant”), the certification 710 (“Silver”), and the certification provider 710 (e.g., “ABC Privacy Certification”). The customer may select a privacy policy link 712 to read the full privacy policy. In some embodiments, the customer may select the “Yes” button 714 to provide explicit consent to the merchant website, and may select the “No” button 716 if the customer chooses not to give explicit consent to the terms of the privacy policy.

Referring now to FIG. 1, the method 100 then proceeds to block 114, where the system provider device 200 detects a violation of the certification associated with the merchant website, and sends a notification of the violation on the customer device 400.

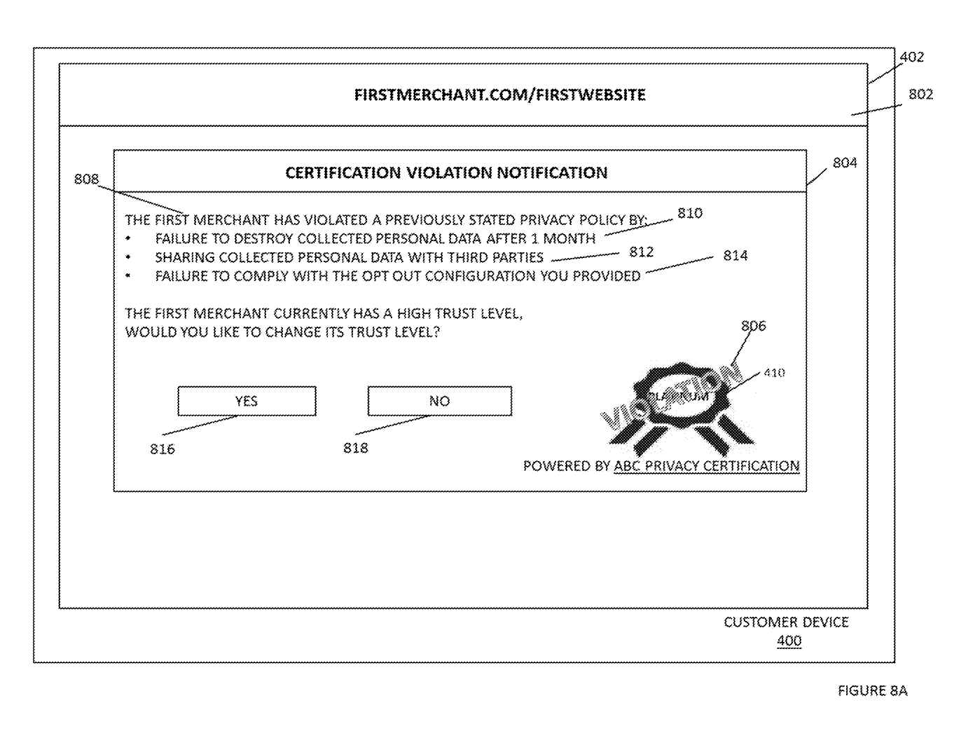

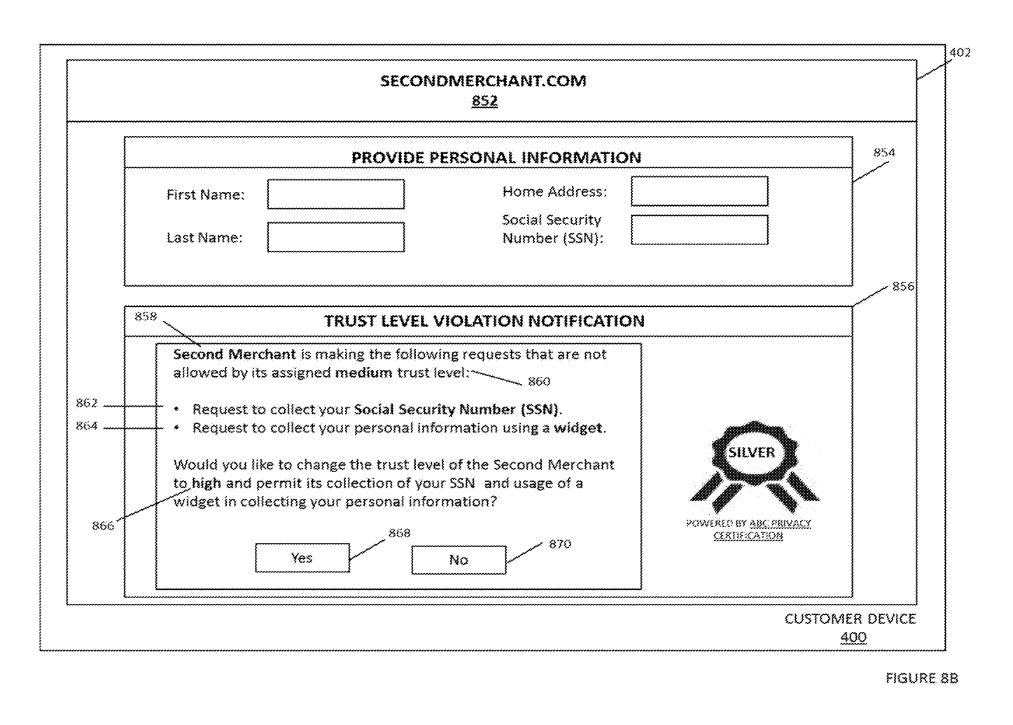

Referring now to FIG. 8A, in some embodiments, the system provider device 200 (or an audit provider device) may audit the merchant device 300 and detect various violations of the certification in the personal information practices of the merchant device 300. In some embodiments, the system provider device 200 has associated a “Platinum” certification with the privacy policy associated with a merchant website provided by the merchant device 300. In an example, using the audit results, the system provider device 200 may determine that the merchant device 300 shares personal data with third parties, thereby violating the third parties sharing requirement 316 of the certification requirement 322A associated with the “Platinum” certification. In another example, the system provider device 200 may determine that the merchant device 200 stores collected personal data for over a month, thereby violating the storage requirement 318 of the certification requirement 322A associated with the “Platinum” certification.

In some embodiments, using the audit results, the system provider device 200 may detect violations in the personal information practices based on the personal information management configuration (e.g., usage configurations of the personal information management configuration) associated with the merchant device 300. For example, a merchant website (e.g., “Firstmerchant.com/firstwebsite”) provided by the merchant device 300 may be associated with a personal information management configuration 506, which includes opt out information 524 providing that the customer choses to opt out of any future advertising from third parties. Using the audit results, the system provider device 200 may determine that the merchant device 200 sends advertising from third parties to the customer, thereby violating the opt out information 508 associated with the personal information management configuration 506.

In some embodiments, upon detecting the violations, the system provider device 200 may display the violation information on the customer device 400. Illustrated in FIG. 8A is an embodiment of the customer device 400 that includes the display device 402 displaying a certification violation notification screen 802 including a certification violation notification section 804. The certification violation notification section 804 may include merchant information 808 (e.g., “First Merchant”), display a violation sign 806 over the certification seal 410, and list various certification violations including storage violation 810 (e.g., “Failure to destroy collected personal data after 1 month”), third parties sharing violation 812 (e.g., “Sharing collected personal data with third parties.”), and opt out violation 814 for failure to comply with the opt out configuration provided by the customer.

In some embodiments, the customer may select the “Yes” button 816 to change the merchant website's trust level (e.g., from “High” to “Medium” or “Low”) using the merchant configurations screen 550 of FIG. 5B. In some embodiments, the customer may select the “No” button 818 and continue to browse the merchant website.

Referring now to FIG. 8B, in some embodiments, the system provider device 200 may detect that the personal data collection on the merchant website provided by the merchant device 300 may violate the the personal information management configuration associated with the merchant website, and in response, provides a notification on the customer device 400. Illustrated in FIG. 8B is an example of a trust level violation notification screen 852 displayed on a display device 402 of a customer device 400 accessing the merchant website (e.g., “SecondMerchant.com”). The trust level violation notification screen 852 includes a personal data collection section 854. As illustrated in the example of FIG. 8B, the customer is asked to provide personal information (e.g., “First Name,” “Last Name,” “Home Address,” and “Social Security Number (SSN)”) to the merchant website. At this stage, the merchant website has not collected personal information from the customer.

In some embodiments, the system provider device 200 may monitor personal data collection requests from the merchant device 300, detect personal data collection violations (also referred to as trust level violations) associated with the personal data collection requests according to the personal information management configuration and the trust level associated with the merchant website, and provide a notification of the personal data collection violation on the customer device 400. In some embodiments, the personal data collection violation may include a personal data collection data type violation. For example, the system provider device 200 may determine a personal data collection data type violation associated with a personal data collection request attempting to collect a particular type of personal information (e.g., “Social Security Number (SSN)”), which is not allowed according to the personal information types 514 of the personal information management configuration 508. For further example, the system provider device 200 may determine a personal data collection technology violation associated with a personal data collection request attempting to use a technology (e.g., a widget) to collect personal information, which is not allowed according to the technology information 518 of the personal information management configuration 508.

In the example illustrated in FIG. 8B, the trust level violation notification screen 852 includes a trust level violation notification section 856 including merchant information 858 (e.g., “Second Merchant”), the current assigned trust level 860 (“medium”), personal data collection data type violation 862 providing that the requested personal information type (e.g., “SSN”) is not allowed by the merchant website's current assigned trust level, and personal data collection technology violation 864 providing that the technology (e.g., a widget) to be used by the merchant website is not allowed by the merchant website's current assigned trust level.

In some embodiments, the customer may be provided the new trust level 864 (e.g., “high”) needed to allow the merchant website to collect the particular type of personal information. The customer may select the “Yes” button 866 to assign the merchant website a new trust level 864 (e.g., “high”), allow the merchant website to perform the requested data collection (e.g., collecting “SSN” and using a widget), and continue to browse the merchant website. The customer may select the “No” button 868 and stop browsing the merchant website.

The examples illustrated in FIGS. 8A and 8B are not intended to be limiting, and the notification may be provided to the customer device in a variety of manners (through a website, an application, as a message (e.g., an email, a text message, a picture message, a “pop-up”, a voice call, etc.) without departing from the scope of the present disclosure.

Referring now to FIG. 1, the method 100 then proceeds to block 116, where the system provider device may determine a new certification associated with an updated privacy policy associated with the merchant website, detect a change between the new certification and the previous certification for the merchant website, and provide a notification of the change to the customer device 400. In some embodiments, the system provider device 200 may update the certification associated with a merchant website by analyzing updated privacy policy received from the merchant device 300. For example, the system provider device 200 may send privacy policy update requests to the merchant device 300 automatically after the customer logs into the merchant website provided by the merchant device 300 on a customer device 400. In some embodiments, the system provider device 200 may pull updated privacy policy information from the merchant device 300 periodically. In some embodiments, the merchant device 300 may push updated privacy policy information to the system provider device 200 without receiving a request from the system provider device.

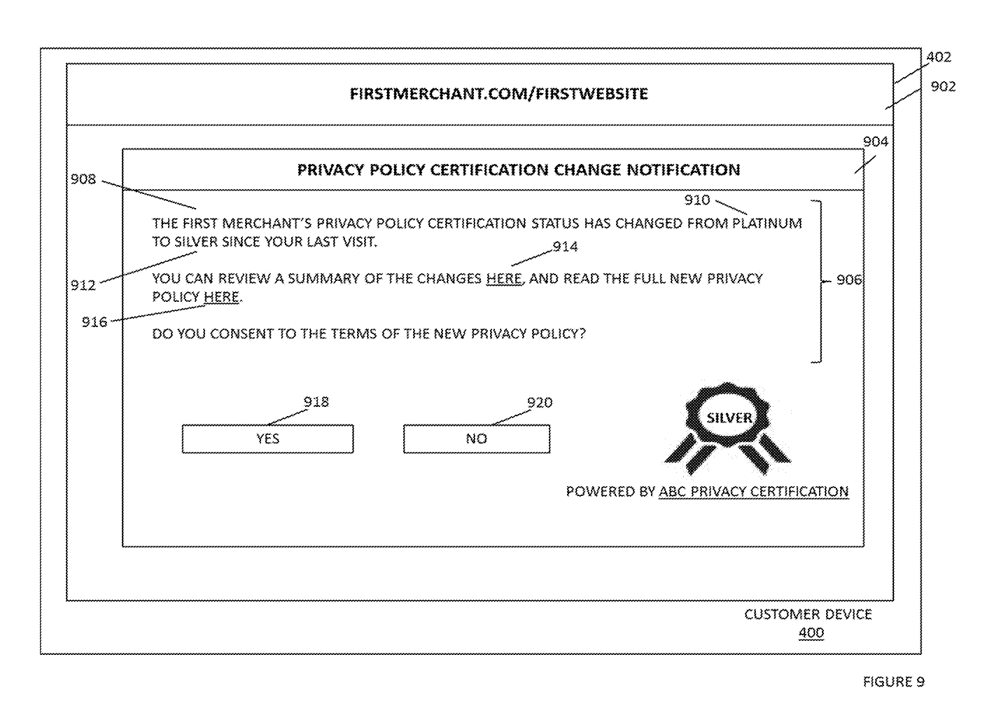

Referring now to FIG. 9, an embodiment of the customer device 400 is illustrated that includes the display device 402 displaying a certification change notification screen 902 including a certification change notification section 904. The certification change notification section 904 may display a privacy policy certification change notification 906 including merchant information 908 (e.g., “First Merchant”), previous certification information 910 (e.g., “Platinum”), and new policy certification information 912 (e.g., “Silver”). The customer may select a change summary link 914 to review a summary of the changes of the privacy policy, or select a link 916 to review the full new privacy policy. In some embodiments, the customer may select the “Yes” button 918 to give consent to the terms of the new privacy policy, and continue to browse the merchant website. In some embodiments, the customer may select the “No” button 920 and refuse to give consent to the new privacy policy, and stop browsing the merchant website.

Thus, systems and methods for providing personal information certification and management have been described that operate to provide merchants and customers a certification system for certifying the merchant's privacy policy and its personal information practices. The systems and methods allow customers to easily understand the general scope of the privacy policies by viewing the certifications provided by a system provider, and allow the customers to provide pre-authorized consent to trusted merchant websites or merchant websites that meet high certification standards. Furthermore, the system provider may ensure the customers that they may trust their personal information with the merchants by auditing the merchants' personal information practices. Moreover, the system provider may provide the customers the convenience of managing the collection and usage of their personal information by various merchants using a single system provider.

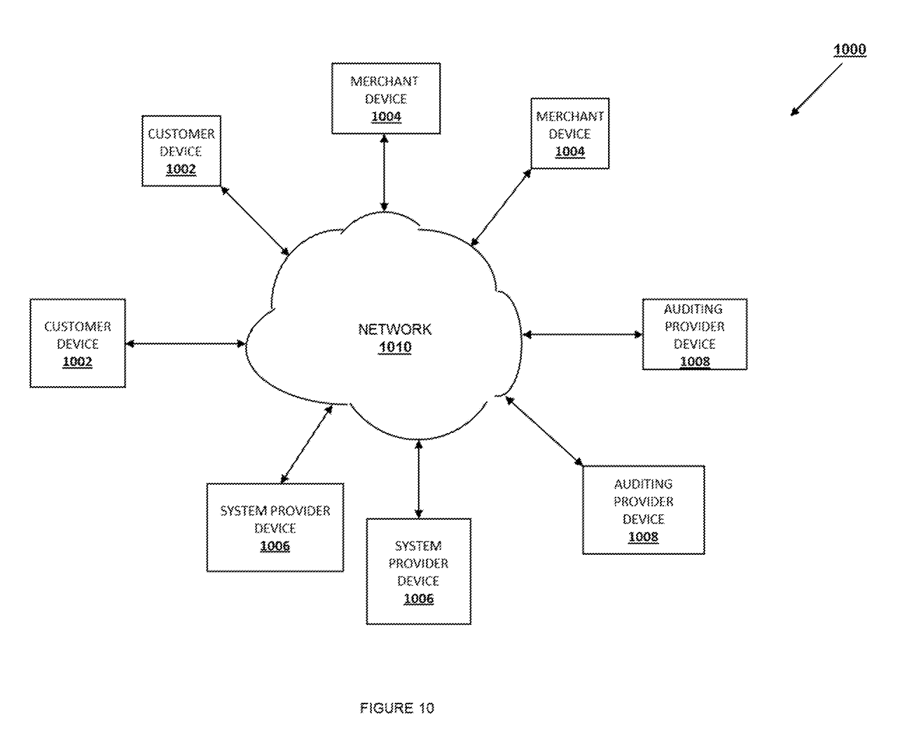

Referring now to FIG. 10, an embodiment of a network-based system 1000 for implementing one or more processes described herein is illustrated. As shown, network-based system 1000 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 10 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of the networked system 1000 illustrated in FIG. 10 includes a plurality of customer devices 1002, a plurality of merchant devices 1004, a plurality of system provider devices 1006, and a plurality of auditing provider devices 1008 in communication over a network 1010. Any of the customer devices 1002 may be the customer devices 400 discussed above and used by the customer discussed above. Any of the merchant devices 1004 may be the merchant device 300 discussed above. The system provider device 1006 may be the system provider device 200 discussed above and may be operated by a system provider such as, for example, PayPal Inc. of San Jose, Calif.

The customer devices 1002, merchant devices 1004, system provider devices 1006, and auditing provider devices 1008 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 1000, and/or accessible over the network 1010.

The network 1010 may be implemented as a single network or a combination of multiple networks. For example, in various embodiments, the network 1010 may include the Internet and/or one or more intranets, landline networks, wireless networks, and/or other appropriate types of networks.

The customer device 1002 may be implemented using any appropriate combination of hardware and/or software configured for wired and/or wireless communication over network 1010. For example, in one embodiment, the customer device 1002 may be implemented as a personal computer of a user in communication with the Internet. In some embodiments, the customer device 1002 may be a wearable device. In some embodiments, the customer device 1002 may be a smart phone, personal digital assistant (PDA), laptop computer, and/or other types of computing devices.

The customer device 1002 may include one or more browser applications which may be used, for example, to provide a convenient interface to permit the customer to browse information available over the network 1010. For example, in one embodiment, the browser application may be implemented as a web browser configured to view information available over the Internet.

The customer device 1002 may also include one or more toolbar applications which may be used, for example, to provide user-side processing for performing desired tasks in response to operations selected by the customer. In one embodiment, the toolbar application may display a user interface in connection with the browser application.

The customer device 1002 may further include other applications as may be desired in particular embodiments to provide desired features to the customer device 1002. The other applications may also include security applications for implementing user-side security features, programmatic user applications for interfacing with appropriate application programming interfaces (APIs) over the network 1010, or other types of applications. Email and/or text applications may also be included, which allow the customer to send and receive emails and/or text messages through the network 1010. The customer device 1002 includes one or more user and/or device identifiers which may be implemented, for example, as operating system registry entries, cookies associated with the browser application, identifiers associated with hardware of the customer device 1002, or other appropriate identifiers, such as a phone number. In one embodiment, the customer identifier may be used by the system provider device 1006 to associate the customer with a particular account as further described herein.

The merchant devices 1004 may be maintained, for example, by a conventional or on-line merchant, conventional or digital goods seller, individual seller, and/or application developer offering various products and/or services in exchange for payment to be received conventionally or over the network 1010. In this regard, the merchant devices 1004 may include a database identifying available products and/or services (e.g., collectively referred to as items) which may be made available for viewing and purchase by the customers.

The merchant devices 1004 also include a checkout application which may be configured to facilitate the purchase by the customers. The checkout application may be configured to accept payment information from the customer through the customer devices 1002, from the system provider through the system provider device 1006, and/or other system providers over the network 1010.

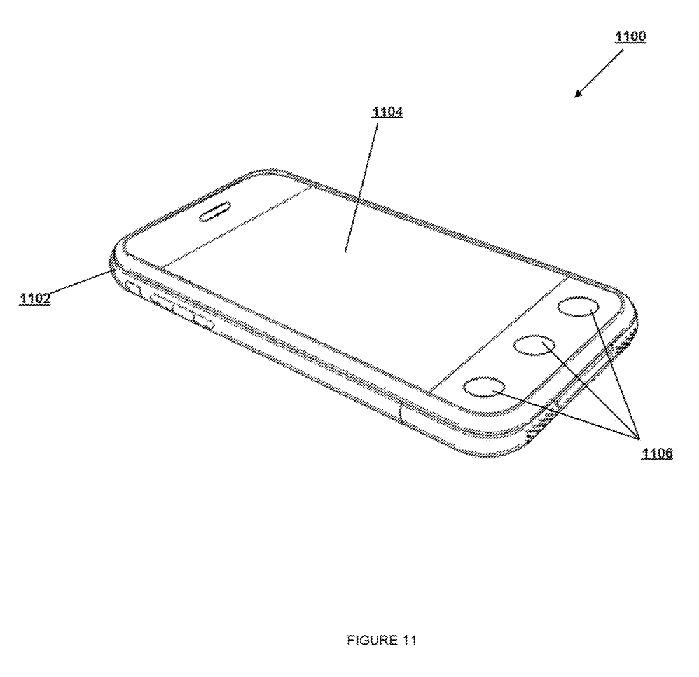

Referring now to FIG. 11, an embodiment of a customer device 1100 is illustrated. The customer device 1100 may be the customer devices 400. The customer device 1100 includes a chassis 1102 having a display 1104 and an input device including the display 1104 and a plurality of input buttons 1106. One of skill in the art will recognize that the customer device 1100 is a portable or mobile phone including a touch screen input device and a plurality of input buttons that allow the functionality discussed above with reference to the method 100. However, a variety of other portable/mobile customer devices may be used in the method 100 without departing from the scope of the present disclosure.

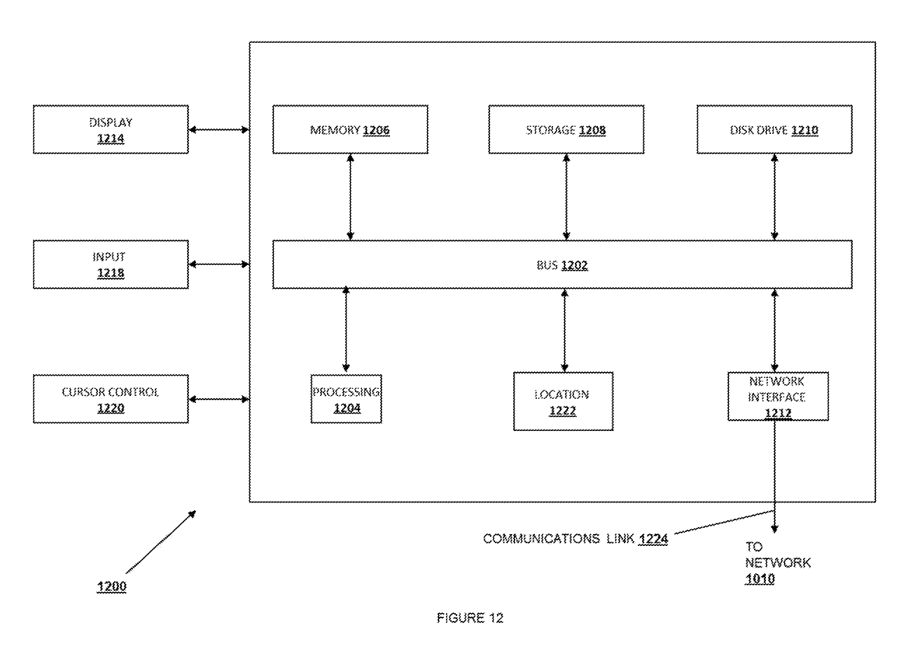

Referring now to FIG. 12, an embodiment of a computer system 1200 suitable for implementing, for example, the system provider devices 200, merchant devices 300, and/or customer device 400, is illustrated. It should be appreciated that other devices utilized by users, persons, and/or system providers in the system discussed above may be implemented as the computer system 1200 in a manner as follows.

In accordance with various embodiments of the present disclosure, computer system 1200, such as a computer and/or a network server, includes a bus 1202 or other communication mechanism for communicating information, which interconnects subsystems and components, such as a processing component 1204 (e.g., processor, micro-controller, digital signal processor (DSP), etc.), a system memory component 1206 (e.g., RAM), a static storage component 1208 (e.g., ROM), a disk drive component 1210 (e.g., magnetic or optical), a network interface component 1212 (e.g., modem or Ethernet card), a display component 1214 (e.g., CRT or LCD), an input component 1218 (e.g., keyboard, keypad, or virtual keyboard), a cursor control component 1220 (e.g., mouse, pointer, or trackball), and a location sensor component 1222 (e.g., a Global Positioning System (GPS) device as illustrated, a cell tower triangulation device, and/or a variety of other location determination devices known in the art). In one implementation, the disk drive component 1210 may comprise a database having one or more disk drive components.

In accordance with embodiments of the present disclosure, the computer system 1200 performs specific operations by the processor 1204 executing one or more sequences of instructions contained in the memory component 1206, such as described herein with respect to the system provider devices 200, the merchant devices 300, the customer devices 400, and/or the auditing provider devices 1008. Such instructions may be read into the system memory component 1206 from another computer readable medium, such as the static storage component 1208 or the disk drive component 1210. In other embodiments, hard-wired circuitry may be used in place of or in combination with software instructions to implement the present disclosure.

Logic may be encoded in a computer readable medium, which may refer to any medium that participates in providing instructions to the processor 1204 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 1210, volatile media includes dynamic memory, such as the system memory component 1206, and transmission media includes coaxial cables, copper wire, and fiber optics, including wires that comprise the bus 1202. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 1200. In various other embodiments of the present disclosure, a plurality of the computer systems 1200 coupled by a communication link 1224 to the network 1010 (e.g., such as a LAN, WLAN, PTSN, and/or various other wired or wireless networks, including telecommunications, mobile, and cellular phone networks) may perform instruction sequences to practice the present disclosure in coordination with one another.

The computer system 1200 may transmit and receive messages, data, information and instructions, including one or more programs (i.e., application code) through the communication link 1224 and the network interface component 1212. The network interface component 1212 may include an antenna, either separate or integrated, to enable transmission and reception via the communication link 1224. Received program code may be executed by processor 1204 as received and/or stored in disk drive component 1210 or some other non-volatile storage component for execution.

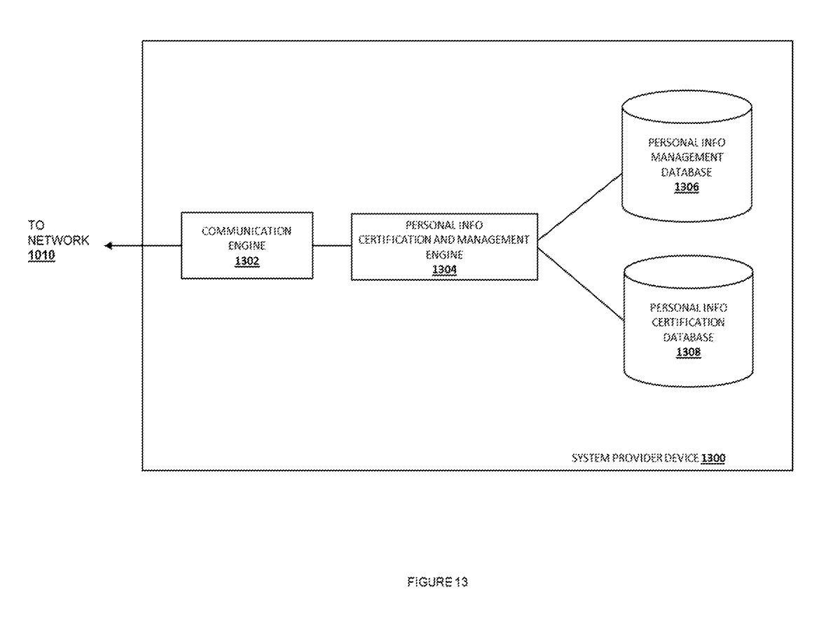

Referring now to FIG. 13, an embodiment of a system provider device 1300 is illustrated. In an embodiment, the system provider device 1300 may be the system provider devices 200 discussed above. The system provider device 1300 includes a communication engine 1302 that is coupled to the network 1010 and to a personal information certification and management engine 1304 that is coupled to a personal information management database 1306 and a personal information certification database 1308. The communication engine 1302 may be software or instructions stored on a computer-readable medium that allows the system provider device 1300 to send and receive information over the network 1010. The personal information certification and management engine 1304 may be software or instructions stored on a computer-readable medium that is operable to define one or more merchant privacy policies, associate a certification with each merchant privacy policy, display the certification on a customer device accessing a merchant website, determine pre-authorized consent associated with the merchant website, detect a violation of the certification, provide a notification of the violation to the customer, and provide any of the other functionality that is discussed above. While the databases 1306 and 1308 have been illustrated as separate from each other and located in the system provider device 1300, one of skill in the art will recognize that any or all of the databases 1306 and 1308 may be combined and/or may be connected to the personal information certification and management engine 1304 through the network 1010 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A personal information certification and management system, comprising:
a non-transitory memory storing one or more pre-authorized consent configurations that are associated with a customer; and
one or more processors coupled to the non-transitory memory and configured to read instructions from the non-transitory memory to cause the system to perform operations comprising:
receiving, from a first device through a network, a first privacy policy associated with a website;
associating, in the non-transitory memory system, the first privacy policy with a first certification;
providing, over the network for display on a customer device in response to the determining the customer device has accessed the website, the first certification;
retrieving, from the non-transitory memory, the one or more pre-authorized consent configurations associated with the customer; and
determining pre-authorized consent associated with the website according to the one or more pre-authorized consent configurations using the first certification and, in response, sending the pre-authorized consent through the network to the first device.

2. The system of claim 1, wherein the one or more processors are configured to read instructions from the non-transitory memory to cause the system to perform operations comprising:
determining a requirement for explicit consent using a location of the customer device; and
sending an explicit consent request through the network to the customer device.

3. The system of claim 1, wherein the one or more processors are configured to read instructions from the non-transitory memory to cause the system to perform operations comprising:
receiving, through the network from the first device, a second privacy policy associated with the website;
associating the second privacy policy with a second certification in the non-transitory memory and, in response, determining that the second certification is different from the first certification; and
providing a notification associated with the first and second certifications through the network for display on the customer device.

4. The system of claim 1, wherein the one or more processors are configured to read instructions from the non-transitory memory to cause the system to perform operations comprising:
retrieving, from the non-transitory memory, a personal information management configuration associated with the website and the customer; and
sending, through the network to the device, the personal information management configuration to configure personal information usage of the personal information associated with the customer.

5. The system of claim 4, wherein the determining pre-authorized consent further includes:
selecting a pre-authorized consent configuration from the one or more pre-authorized consent configurations according to the first certification and the personal information management configuration; and
determining pre-authorized consent associated with the first website using the selected pre-authorized consent configuration.

6. The system of claim 4, wherein the one or more processors are configured to read instructions from the non-transitory memory to cause the system to perform operations comprising:
monitoring personal data collection requests through the network from the first device;
determining a personal data collection violation associated with at least one of the personal data collection requests according to the personal information management configuration; and
providing a notification of the personal data collection violation through the network for display on the customer device.

7. The system of claim 6, wherein the at least one of the personal data collection requests is associated with a personal data collection technology; and
wherein the personal data collection violation includes a personal data collection technology violation.

8. The system of claim 1, wherein the one or more processors are configured to read instructions from the non-transitory memory to cause the system to perform operations comprising:
auditing personal information practices of the first device to detect a violation of the first certification; and
providing a notification of the violation of the first certification through the network for display on the customer device.

9. A method, comprising:
accessing, by a customer device through a network, a website associated with a first device;
receiving, by the customer device through the network from a service provider device, a first certification associated with a first privacy policy associated with the website;
providing, by the customer device through the network to the service provider device, one or more pre-authorized consent configurations associated with the customer,
wherein the one or more pre-authorized consent configurations are used to determine pre-authorized consent associated with the website using the first certification.

10. The method of claim 9, further comprising:
providing, by the customer device through the network to the service provider device, a location of the customer device used to determine a requirement for explicit consent; and
receiving, by the customer device through the network from the service provider device, an explicit consent request through the network.

11. The method of claim 9, further comprising:
receiving, by the customer device through the network from the service provider device, a privacy policy certification change notification associated with the first certification and a second certification associated with a second merchant privacy policy associated with the website.

12. The method of claim 9, further comprising:
providing, by the customer device to the service provider device, a personal information management configuration associated with the website and the customer,
wherein the personal information management configuration is used to configure personal information usage of the personal information associated with the customer by the first device.

13. The method of claim 12, wherein the determining pre-authorized consent further includes:
selecting, by the service provider device, a pre-authorized consent configuration from the one or more pre-authorized consent configurations according to the first certification and the personal information management configuration; and
determining, by the service provider device, pre-authorized consent associated with the website using the selected pre-authorized consent configuration.

14. The method of claim 12, further comprising:
receiving, by the customer device through the network from the first device, personal data collection requests;
sending, by the customer device through the network to the service provider device, the personal data collection requests; and
receiving, by the customer device through the network from the service provider device, a notification of a personal data collection violation associated with at least one of the personal data collection requests,
wherein the notification is determined according to the personal information management configuration.

15. The method of claim 14, wherein the at least one of the personal data collection requests is associated with a personal data collection technology; and
wherein the personal data collection violation includes a personal data collection technology violation.

16. A non-transitory computer-readable medium having machine-readable instructions executable to cause a machine to perform operations comprising:
providing, through a network to a service provider device, a first privacy policy associated with a website,
wherein the first privacy policy is associated, in a database, with a first certification;
determining that a customer device associated with a customer is accessing the website;
providing through a network for display on the website on the customer device the first certification; and
receiving, through the network from the service provider device, pre-authorized consent associated with the website and the customer,
wherein the pre-authorized consent is determined according to one or more pre-authorized consent configurations retrieved from a database.

17. The non-transitory machine-readable medium of claim 16, wherein the operations further comprise:
sending an explicit consent request through the network for display on the website on the customer device.

18. The non-transitory machine-readable medium of claim 16, wherein the operations further comprise:
sending, through the network to the service provider device, a second privacy policy associated with the website,
wherein the second privacy policy is associated with a second certification in the database;
receiving, through a network from the service provider device, a notification associated with the first and second certifications; and
displaying, through the network, the notification on the website on the customer device.

19. The non-transitory machine-readable medium of claim 16, wherein the operations further comprise:
receiving, through the network from the service provider device, a personal information management configuration associated with the customer; and
configuring personal information usage of personal information associated with the customer.

20. The non-transitory machine-readable medium of claim 16, wherein the operations further comprise:
generating a second privacy policy using a privacy policy generator provided by the service provider device.
